(19) United States
(12) Patent Application Publication
(10) Pub. No.: US 2026/0328572 A1
(43) Pub. Date: Oct. 22, 2026

(54) APPARATUS AND METHOD OF PERFORMING PATH FINDING

(71) Applicant: ELECTRONICS AND TELECOMMUNICATIONS RESEARCH INSTITUTE, Daejeon (KR)

(72) Inventor: Jiho Chang, Daejeon (KR)

(21) Appl. No.: 19/468,691

(22) Filed: Feb. 3, 2026

(30) Foreign Application Priority Data
Feb. 5, 2025 (KR) 10-2025-0014318

(51) Int. Cl. G01C 21/28; G01C 21/00; G06T 3/40; G06T 7/11; G06T 7/73

(52) U.S. Cl. CPC G01C 21/28; G01C 21/3811; G01C 21/3841; G06T 3/40; G06T 7/11; G06T 7/73; G06T 2207/10028

(57) ABSTRACT

A robot for performing path finding includes an input unit configured to obtain an image through a camera, a sensing unit configured to detect a position of an object through a Lidar, a memory configured to store data obtained based on the path finding and a down-scaled map generated based on the data, and a processor functionally connected to the input unit, the sensing unit, and the memory to control an overall operation of the robot. The processor controls the robot to scan a surrounding environment of the robot by using the camera and the Lidar and generate the down-scaled map including a path structure of a symbolic form by using a connection line and an object placement structure where objects detected as a result of the scan are placed in a specific form.

### CROSS-REFERENCE TO RELATED APPLICATIONS

This application claims the benefit of the Korean Patent Application No. 10-2025-0014318 filed on Feb. 5, 2025, which is hereby incorporated by reference as if fully set forth herein.

### BACKGROUND

### 1. Field of the Invention

The present disclosure relates to a method which may enable a robot to recognize an approximate position without using a high-precision map in a robot navigation system of record-replay method, and more particularly, to a method which may recognize a shape of a path and surrounding objects to estimate a current position of a robot and may enable robot navigation even without complicated sensing or high-performance processing, based on the estimated current position.

### 2. Description of Related Art

Recent autonomous driving technology generates a precise map by using sensors such as Lidar, cameras, and global positioning system (GPS) and predicts a position of a robot or a vehicle, based on the generated map. Most representative autonomous driving technology research is a method where a robot scans a surrounding environment by using simultaneous localization and mapping (SLAM) technology and generates a map based on the surrounding environment to track a position in real time. SLAM is widely used up to various robot platforms from autonomous driving vehicles.

The SLAM system simultaneously performs high-accuracy environment recognition and position estimation through sensors, but because the SLAM system should require high-level computational capability and process a large amount of data, high-performance computers and large-capacity storage devices are essential. Particularly, in autonomous driving vehicles, because data collected through a plurality of Lidar sensors is processed in real time, high-precise maps are needed, and thus, it is essential to track an accurate position in complicated environments such as highways and urban areas.

However, in the robot system (particularly, small robots), because the constraints of power and weight are large, it may be difficult to process high-performance computers or massive data used in autonomous driving vehicles. Because the most of small robots depend on battery power, when small robots use a high-performance sensor and computer system, the lifetime of battery may be shortened, and a movable distance of each robot may be largely limited. Therefore, a lightweight positioning and navigation method based on the embedded system is required. Unlike conventional autonomous driving vehicles, robots should use the embedded system instead of a high-performance computer, and due to this, it is practically difficult to generate and store a complicated entire map.

Moreover, unlike autonomous driving vehicles, many robot applications often move a predetermined route such as a commuting path or a specific task route. In such a case, it is more efficient to use a simplified map based on only route information and a key landmark than a complicated three-dimensional (3D) map. For example, in the case of guide dog robots or robots used in logistics warehouses, because a path to destination is predefined, it is more suitable to store a simple one-dimensional (1D) map or path information than storing an entire 3D map.

The conventional autonomous driving robot system requires a high-precise map and mainly combines SLAM technology with sensors such as GPS, Lidar, and a high-performance camera to track a position of a robot in real time. For example, Waymo, Google's autonomous driving vehicle project, has been designed to use SLAM and a precise pre-built map to enable a vehicle to accurately perform autonomous driving in a road environment. The Waymo system detects all objects around a vehicle in real time, generates a high-resolution map based on the detected objects, and calculates a desired path needed for autonomous driving.

However, such a system needs a very number of computational resources and power, and particularly, it is difficult to apply the system to small robots having limited computational capability or robots driven with a battery, and because high-precision sensors such as Lidar are expensive and heavy, the use of several systems is not suitable for small robots. Also, due to limited computational resources, such robots are actually impossible to build a 3D map of an entire environment in real time and track a position based on the 3D map, and accordingly, a new system is needed for small robots which may use limited resources and may recognize a position with relatively simpler data and methods.

### SUMMARY

An aspect of the present disclosure is directed to providing a method which may enable an autonomous driving robot to perform path finding without requiring a high-precision three-dimensional (3D) map and may enable a small robot including a limited computing resource and storage space to perform efficient path recognition and re-finding.

To this end, the present disclosure is for providing a method which may detect an object based on the record and replay method, may recognize an environment through semantic segmentation, and may provide a path structure through a simplified one-dimensional (1D) map and symbolization.

Therefore, the present disclosure may efficiently compress data and save storage resources by excluding undesired information, and thus, may be applied to an embedded system-based robot.

The objects of the present disclosure are not limited to the aforesaid, but other objects not described herein will be clearly understood by those skilled in the art from descriptions below.

To achieve these and other advantages and in accordance with the purpose of the invention, as embodied and broadly described herein, there is provided a robot for performing path finding, the robot including: an input unit configured to obtain an image through a camera; a sensing unit configured to detect a position of an object through a Lidar; a memory configured to store data obtained based on the path finding and a down-scaled map generated based on the data; and a processor functionally connected to the input unit, the sensing unit, and the memory to control an overall operation of the robot, wherein the processor controls the robot to scan a surrounding environment of the robot by using the camera and the Lidar and generate the down-scaled map including a path structure of a symbolic form by using a connection line and an object placement structure where objects detected as a result of the scan are placed in a specific form.

Also, in the present disclosure, the processor may set the detected object as a landmark and places a figure, representing the set landmark, in the specific form.

Also, in the present disclosure, the processor may set a current position of the robot as center coordinates and places a figure, associated with the detected object, in the specific form with respect to a viewpoint of the robot on the detected object.

Also, in the present disclosure, the specific form may be a radial form, a grid form, or a tree form.

Also, in the present disclosure, the processor may recognize a path of the surrounding environment through semantic segmentation and may transform a result of the recognition into a bird's eye view (BEV) form to generate the path structure of symbolic form.

Also, in the present disclosure, the path may include a pedestrian road, an intersection, and a crosswalk.

Also, in the present disclosure, when a difference between nodes detected based on occurrence of an event and nodes in a traveling path of the robot pre-stored in the memory is detected, the processor may generate a node, detected based on the occurrence of the event, as a new node.

Also, in the present disclosure, the processor may reflect the generated new node in the traveling path of the robot to update the traveling path of the robot.

Also, in the present disclosure, the occurrence of the event may be a position change of an object, detection of a new object, or a change in the path of the surrounding environment.

In another aspect of the present invention, there is provided a method of performing path finding by using a robot, the method including: a step of scanning a surrounding environment of the robot by using a camera and a Lidar; a step of generating a path structure of a symbolic form by performing semantic segmentation and bird's eye view (BEV) transformation on a path of the surrounding environment through the scanning; a step of generating an object placement structure where objects detected through the scanning are placed in a specific form; and a step of generating a down-scaled map including the path structure of symbolic form and the object placement structure.

Also, in the present disclosure, the step of generating the object placement structure may include: a step of setting a current position of the robot as center coordinates; and a step of placing a figure, associated with the detected object, in the specific form with respect to a viewpoint of the robot on the detected object.

Also, in the present disclosure, the specific form may be a radial form, a grid form, or a tree form.

Also, in the present disclosure, the step of generating the path structure of symbolic form may include: a step of recognizing the path of the surrounding environment through semantic segmentation; and a step of transforming a result of the recognition into a BEV form.

Also, in the present disclosure, the path may include a pedestrian road, an intersection, and a crosswalk.

Also, in the present disclosure, the method may further include a step of, when a difference between nodes detected based on occurrence of an event and nodes in a traveling path of the robot pre-stored in a memory is detected, generating a node, detected based on the occurrence of the event, as a new node.

Also, in the present disclosure, the method may further include a step of reflecting the generated new node in the traveling path of the robot to update the traveling path of the robot.

Also, in the present disclosure, the occurrence of the event may be a position change of an object, detection of a new object, or a change in the path of the surrounding environment.

Also, in the present disclosure, the step of generating the object placement structure may include: a step of setting the detected object as a landmark; and a step of placing a figure, representing the set landmark, in the specific form.

In another aspect of the present invention, there is provided an autonomous driving apparatus for performing path finding, the autonomous driving apparatus including: a memory configured to store data associated with path finding; and a processor configured to scan a surrounding environment by using a camera and a Lidar, generate a path structure of a symbolic form by performing semantic segmentation and bird's eye view (BEV) transformation on a path recognized in the surrounding environment, generate an object placement structure where objects detected through the scan are placed in a specific form, and generate a down-scaled map including the path structure of symbolic form and the object placement structure.

The present disclosure may perform symbolization to store only a significant landmark and a path structure in a simplified form, and thus, may prevent the redundant storage of unnecessary data, may significantly save a storage space, and may shorten and store a traveled distance by using odometry data, thereby maximizing data efficiency.

Moreover, the present disclosure may allow a robot to quickly reference information in the middle of path finding through a method which represents a path structure of each section with a simplified symbol, may generate a new node even when a significant landmark or a pedestrian path structure is changed in moving between nodes, and may enhance a finding speed and may increase accuracy by using efficiently using previous data.

Moreover, the present disclosure may generate a new node only when an environment is changed in the middle of path finding, and when a difference with a pre-existing path, may reflect the difference to correct a path, and thus, may allow an autonomous driving robot to continuously maintain an accurate path in a dynamic environment, thereby enhancing real-time response capability.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram illustrating an example of an internal block diagram of a robot to which a method proposed in the present disclosure may be applied.

FIG. 2 is a diagram illustrating an example of a simplified map structure proposed in the present disclosure.

FIG. 3 is a diagram illustrating an example of the form of an object placement structure defined in the present disclosure.

FIG. 4 is a diagram illustrating an example of recording with a new node based on a movement of a robot.

FIG. 5 illustrates a process where a robot finds a path in an urban environment and records the found path.

FIG. 6 is a flowchart illustrating an example of a path finding method of a robot using a simplified map structure proposed in the present disclosure.

### DETAILED DESCRIPTION OF THE INVENTION

The terminology used herein is for the purpose of describing particular embodiments only and is not intended to be limiting of the disclosure. Unless otherwise defined, all terms used herein have the same meaning as commonly understood by one of ordinary skill in the art to which this disclosure pertains and should not be interpreted as having an excessively comprehensive meaning nor as having an excessively contracted meaning. If technical terms used herein is erroneous that fails to accurately express the technical idea of the present disclosure, it should be replaced with technical terms that allow the person in the art to properly understand. The general terms used herein should be interpreted according to the definitions in the dictionary or in the context and should not be interpreted as an excessively contracted meaning.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present disclosure, and similarly, the second element may also be referred to as the first element.

Hereinafter, embodiments described in the present disclosure will be described in detail with reference to the accompanying drawings, like reference numerals refer to like or similar elements regardless of reference numerals, and their repeated descriptions are omitted.

Moreover, in describing technology described in the present disclosure, when it is determined that detailed descriptions of related technology known to those of ordinary skill in the art obscure the gist of technology described in the present disclosure, the detailed descriptions are omitted. Also, the accompanying drawings are merely for helping easily understand the inventive concept described in the present disclosure, and it should not be construed that the accompanying drawings limit the inventive concept.

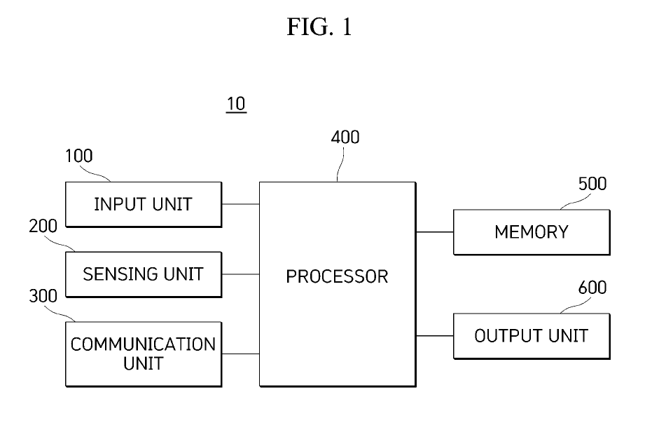

FIG. 1 is a diagram illustrating an example of an internal block diagram of a robot to which a method proposed in the present disclosure may be applied.

Referring to FIG. 1, a robot 10 according to embodiments of the present disclosure may include an input unit 100, a sensing unit 200, a communication unit 300, a processor 400, a memory 500, and an output unit 600 and may be referred to as a robot device, a mobile device, a terminal, an artificial intelligence (AI) device, an intelligent device, or an autonomous driving device.

The elements illustrated in FIG. 1 may not be essential, and thus, a robot may be implemented with more or fewer elements than the number of elements of FIG. 1.

Hereinafter, each element of the robot will be sequentially described.

The input unit 100 may be for an audio signal input, a video signal input, or a user input. The input unit 100 may include a camera and a microphone for the audio signal input or the video signal input.

The camera may process an image frame such as a still image or a moving image, obtained by an image sensor in a capture mode. The processed image frame may be displayed on a display unit and may include an RGB camera, AI camera, and/or the like.

The sensing unit 200 may detect a current state and a surrounding environment of a robot such as a position of the robot, an orientation of the robot, and an acceleration/deceleration of the robot to generate a sensing signal for controlling an operation of the robot. The sensing unit 200 may include Lidar, a laser, and/or the like.

The communication unit 300 may include one or more modules which enable wired/wireless communication between the robot and an external device. That is, the communication unit 300 may include a short-range communication module, a mobile communication module, and/or the like.

The short-range communication module may denote a module for short-range communication. Short-range communication technology may use Bluetooth, radio frequency identification (RFID), infrared data association (IrDA), ultra-wideband (UWB), and ZigBee.

Moreover, the communication unit 300 may additionally include a position information module. The position information module may be a module for obtaining a position of the robot, and as a representative example, may include a global positioning system (GPS) module.

The processor 400 may denote a module that controls an overall operation of the robot and may be referred to as a control unit, a control module, a controller, a microcontroller, or a microprocessor. The processor 400 may be implemented with hardware, firmware, software, or a combination thereof.

The processor 400 may include an application-specific integrated circuit (ASIC), another chipset, a logic circuit, and/or a data processing device.

The memory 500 may store a program for an operation of the processor 400 and may temporarily store input/output data also. The memory 500 may be a medium for storing various information about the robot and may be connected to the processor 400 to store a program, an application, a general file, and input/output data for an operation of the processor 400. The memory 500 may be a storage medium of at least one type among a flash memory type, a hard disk type, a multimedia card micro type, a card-type memory (for example, SD or XD memory), random access memory (RAM), static random access memory (SRAM), read-only memory (ROM), electrically erasable programmable read-only memory (EEPROM), programmable read-only memory (PROM), a magnetic memory, a magnetic disk, and an optical disk.

The output unit 600 may be for generating an output associated with vision, hearing, or touch and may include a display unit, an audio output module, and/or the like.

Although not illustrated in FIG. 1, the robot may further include a power supply unit representing a module that receives external power and internal power to supply power needed for an operation of each element, based on control by the processor 400.

Hereinafter, a method where an autonomous driving robot proposed in the present disclosure recognizes a path in a complicated environment, simplifies and stores the recognized path, and finds the path will be described. The method proposed in the present disclosure may have the main technical feature where a map structure simplified through object detection, semantic segmentation, and bird's eye view (BEV) transformation is used in path finding.

First, the robot may store a record and replay method and recorded (or collected) data.

In a case of finding a path, the robot may scan a surrounding environment based on the Lidar of the sensing unit 200 and a camera (for example, RGB camera) of the input unit 100 and may record the path, based on the scanned surrounding environment. That is, the robot may analyze the scanned surrounding environment through object detection and semantic segmentation methods, may recognize a path structure such as a pedestrian path or a road around the robot, and may encode recognized path structure information to generate a simplified (or abbreviated) one-dimensional (1D) map. Also, the robot may record a pedestrian path structure between nodes on data found in a record mode and may add additional data to the 1D map based on a traveled distance between nodes to store the 1D map. A node described herein may denote a point at which the robot generates a simplified 1D map based on a scanned result obtained by scanning the surrounding environment and may include a pre-set node, a node which is changed due to the occurrence of an event, and a newly added node. The event may include an event where a movement path of the robot is changed or an event where the robot recognizes a new object.

When the robot detects the occurrence of an event like a case of sensing a change in a path or recognizing a new object, the robot may generate a new node corresponding to a point at which the event has occurred, may record the new node, and may store data based on section-based distance and time. The recorded and stored data may be used in a replay mode of the robot, and then, may be referenced in a case which again moves to a previously found path.

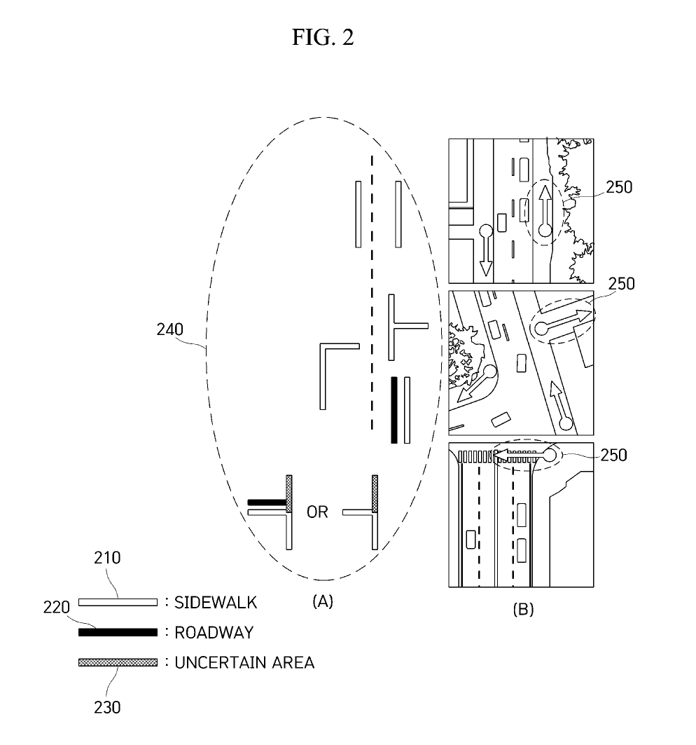

FIG. 2 is a diagram illustrating an example of a simplified map structure proposed in the present disclosure.

Referring to FIG. 2, reference numeral 250 illustrates an example of a result obtained by obtaining a movement path of a robot through semantic segmentation and transforming the movement path into a BEV form, and reference numeral 240 illustrates an example of a map structure where complicated data of 250 is simplified by using a connection line. In the connection line of 240, reference numeral 210 may represent a sidewalk, reference numeral 220 may represent a roadway, and 230 may represent an uncertain area.

As described above, the robot may scan a surrounding environment by using the Lidar and the RGB camera when finding a path. In the scan process, the robot may recognize the path structure (sidewalks, intersections, crosswalks, etc.) of the found surrounding environment through semantic segmentation and may transform the recognized path structure into a BEV form as illustrated in FIG. 2B. Also, the robot may symbolize the path structure of each section based on a result transformed into the BEV form and may generate a simplified map structure including a plurality of connection lines 210 to 230 as illustrated in 240.

In 250, a position and a direction of the robot are illustrated by a black arrow 250, and a symbolization 240 of the path structure of each section is illustrated by a pedestrian road (or sidewalk) 210 and a roadway 220 with respect to the robot, as illustrated in 240. Path structure information about the symbolized path structure may be usefully used in a case where the robot re-finds a path subsequently.

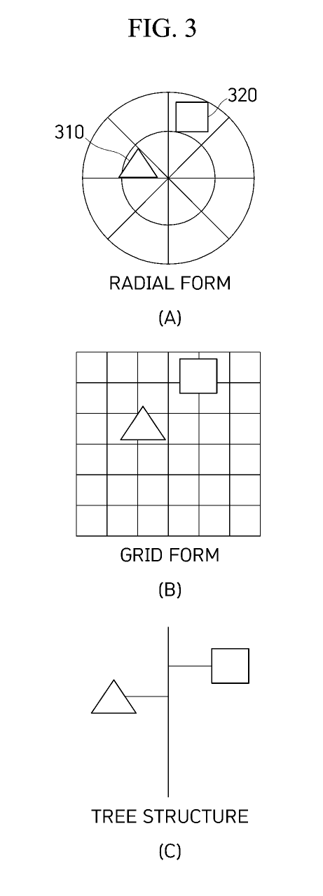

Moreover, when the robot detects an object in a process of scanning the surrounding environment in the middle of path finding, the robot may set the detected object as a characteristic landmark. As illustrated in FIG. 3, the robot may generate and store an object placement structure where the detect object is placed in one form among forms of various structures such as a radial structure, a grid structure, and a tree structure. An object placement method of FIG. 3 may set a current position of the robot as center coordinates and may place the detected object in one structure form (radial, grid, or tree form) with respect to a viewpoint of the robot. FIG. 3 illustrates an example of a form of the object placement structure defined in the present disclosure.

That is, in FIG. 3, (A) illustrates an example where objects are placed in a radial structure form, and in the radial structure form, detected objects may be placed in a radial form with respect to the robot, and each object may be placed based on a distance. In FIG. 3, (B) illustrates an example where objects are placed in a grid structure form, and in the grid structure form, a space may be divided into grids of a certain size, and an object may be placed in a divided compartment of a corresponding grid. In FIG. 3, (C) illustrates an example where objects are placed in a tree structure form, and in the tree structure form, objects may be placed by expressing a relationship between the objects as a tree structure with respect to a main node.

In FIG. 3 (A) to (C), each of a triangle 310 and a square 320 represents a featural landmark set by the robot.

Hereinafter, a method of generating a new node by using a robot in the middle of path finding will be described with reference to the drawings.

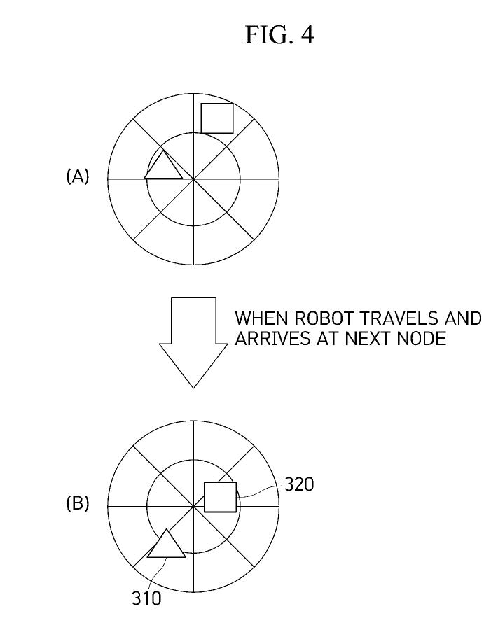

While finding a path, when a difference between nodes included in the found path and previously recorded nodes occurs, a robot may determine or generate, as a new node, a node which is not included in the previously recorded nodes. As described above, the reason that the new node occurs may be based on a position change of an object, the detection of a new object, or a change in a path structure. Also, the new node may be newly generated based on a certain distance or over time. Determining or generating of the new node may be for enabling the robot to accurately reflect a changed surrounding environment in path finding to update a path and accurately move by using the updated path. FIG. 4 illustrates an example of recording a new node based on a movement of a robot. In FIG. 4, (A) illustrates a pre-existing node, and in FIG. 4, (B) illustrates a new node. In (B) of FIG. 4, two objects may be far away from each other, and in FIG. 4, (B) may be a case where a distance between two objects is reduced or changed by a movement of the robot, and thus, the robot may record a changed object as a new node.

A landmark set by the robot may be a new node or a waypoint, and the landmark may be used as an important reference point which may be referenced by the robot while the robot is moving.

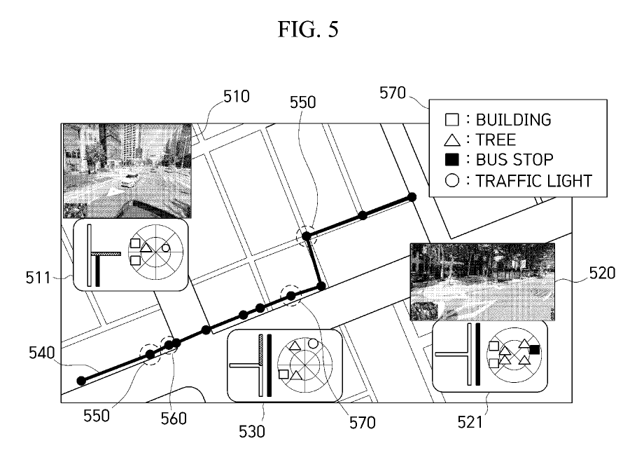

Under a condition for generating a new node, when a new object is detected, or a position of a pre-existing object is changed, or a distance or a time varies to be a threshold or more, a corresponding object may be determined as a new node. Also, the robot may set an important point between nodes as a waypoint, and a type, position information, a pedestrian path, and a road structure of an object may be recorded and stored as explanation information together. FIG. 5 illustrates an example of a waypoint proposed in the present disclosure. That is, FIG. 5 illustrates a process of finding a path and recording the found path in an urban environment by using a robot. Referring to FIG. 5, it may be seen that the robot recognizes a landmark in a traveling path of the robot to set the landmark as a main node and records and stores information about the landmark.

The robot may scan a surrounding environment by using a Lidar and an RGB camera per main section (for example, sidewalks, intersections, traffic lights, etc.) while finding a path. In FIG. 5, 510 and 520 represent screens showing a scanned surrounding environment. The main section may be set as a waypoint. Through the scan process, the robot may recognize a path structure of each of roads, sidewalks, and intersections through semantic segmentation, and the recognized information may be stored in simplified map structure forms 511, 521, and 530 through BEV transformation. In FIG. 5, a path 540 illustrated by a red line represents a main path through which the robot travels, and red dots 550 in the path 540 represent main nodes recorded by the robot.

The robot may record a path structure and landmarks 511, 521, and 530 of a corresponding section in each node.

For example, as illustrated in FIG. 5, landmarks such as buildings, trees, bus stops, and traffic lights may be represented by various symbols 570 such as squares, triangles, and circles. Furthermore, the landmarks may be important points capable of being referenced in a path through which the robot travels, and based on each position, the landmarks may be stored in radial, grid, or tree forms as described above with reference to FIG. 3.

Referring to FIG. 5, from a viewpoint of the robot, landmarks (for example, traffic lights, trees, bus stops, etc.) in each node may be placed in a radial form. It may be seen that a path structure between nodes is stored and displayed as a simplified map structure by symbolizing distinction between roads and sidewalks (511, 521, and 530). In the path structure of FIG. 5, black represents a sidewalk, blue represents a roadway, and red represents an uncertain area.

Moreover, when the robot detects traveling of a certain distance or the elapse of a certain time or a significant change in a path structure in the middle of path finding, the robot may generate new nodes 560 and 570. The nodes 560 and 570 corresponding to the red dots in a traveling path of the robot of FIG. 5 may be generated when a landmark in the path differs from before or a new object is recognized. For example, in a node corresponding to 560, it may be seen that, as a new traffic light and tree are detected while passing through an intersection, the robot generates a detected node as a new node.

Through the process described above, the robot may store information about an object detected when finding a path, namely, may store detected object information (including a landmark, a node, etc.) in a simplified map structure represented by a connection line and may use the simplified map structure when finding a path. That is, the robot may not record in detail all data obtained through a scan process of a surrounding environment and may record only desired information by simplifying a featural landmark and path structure information, thereby saving a storage space and maximizing the efficiency of data. For example, the robot may record only relative position information between objects or storing only a change between major nodes in a path, thereby decreasing data throughput.

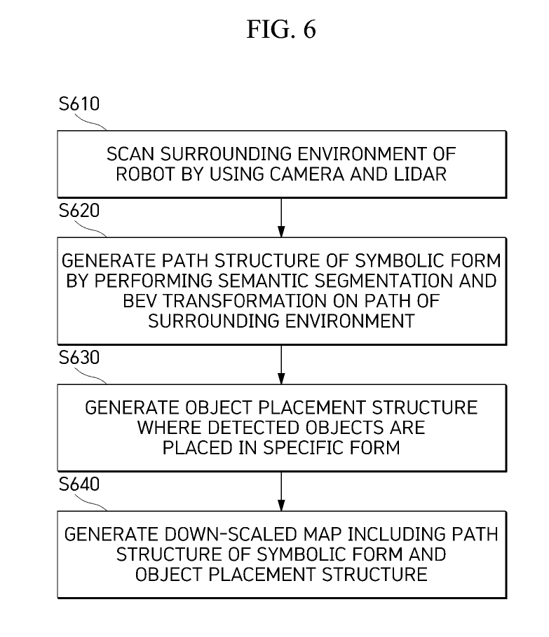

FIG. 6 is a flowchart illustrating an example of a path finding method of a robot using a simplified map structure proposed in the present disclosure.

First, a robot may scan a surrounding environment by using a camera and a lidar in step S610.

Then, in step S620, the robot may generate a path structure of a symbolic form on a path of the surrounding environment through semantic segmentation and BEV transformation, based on the scan.

Subsequently, in step S630, the robot may generate an object placement structure where objects detected through the scan are placed in a specific form.

Subsequently, in step S640, the robot may generate a down-scaled map including the path structure of symbolic form and the object placement structure.

Step S620 (i.e., a step of generating the path structure of symbolic form) may include a process of recognizing a path of the surrounding environment through semantic segmentation and transforming a recognized result into a BEV form.

Step S630 (i.e., a step of generating the object placement structure) may include a process of setting the detected objects as a landmark and placing a figure, representing the set landmark, in the specific form.

In step S630, the robot may set a current position of the robot as center coordinates and may place a figure, associated with the detected object, in the specific form with respect to a viewpoint of the robot on the object.

Here, the specific form may be a radial, grid, or tree form, and the path may include a pedestrian road, an intersection, and a crosswalk.

Additionally, when the robot detects a difference between nodes detected when an event occurs and nodes in a traveling path of the robot stored in a memory, the robot may generate the node, detected through the occurrence of the event, as a new node and may reflect the generated new node in the traveling path of the robot to update the traveling path of the robot.

The occurrence of the event may be a position change of an object, the detection of a new object, or a change in the path of the surrounding environment.

The embodiments described above may be that the elements and features of the present disclosure are combined in a certain form. Unless separately and explicitly described, each element or feature should be considered to be selective. Each element or feature may be implemented in a form which is not combined with another element or feature. Also, the embodiment of the present disclosure may be configured by combining some elements and/or features with each other. The order of operations described in the embodiments of the present disclosure may be changed. Some elements or features of a certain embodiment may be included in another embodiment, or may be replaced with an element or a feature corresponding to another embodiment. In Claim, it is obvious that an embodiment may be configured by combining claims having no explicit citation relationship, or may be included as a new claim by correction after patent application.

The embodiments according to the present disclosure may be implemented by various means (for example, hardware, firmware, software, or a combination thereof). In implementation based on hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

In implementation based on firmware or software, the embodiments of the present disclosure may be implemented in a form such as a module, a process, or a function, which performs functions or operations described above. A software code may be stored in a memory and may be driven by a processor. The memory may be disposed in or outside the processor and may transfer or receive data to or from the processor, based on various means known to those of ordinary skill in the art.

The present disclosure may perform symbolization to store only a significant landmark and a path structure in a simplified form, and thus, may prevent the redundant storage of unnecessary data, may significantly save a storage space, and may shorten and store a traveled distance by using odometry data, thereby maximizing data efficiency.

Moreover, the present disclosure may allow a robot to quickly reference information in the middle of path finding through a method which represents a path structure of each section with a simplified symbol, may generate a new node even when a significant landmark or a pedestrian path structure is changed in moving between nodes, and may enhance a finding speed and may increase accuracy by using efficiently using previous data.

Moreover, the present disclosure may generate a new node only when an environment is changed in the middle of path finding, and when a difference with a pre-existing path, may reflect the difference to correct a path, and thus, may allow an autonomous driving robot to continuously maintain an accurate path in a dynamic environment, thereby enhancing real-time response capability.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A robot for performing path finding, the robot comprising:
an input unit configured to obtain an image through a camera;
a sensing unit configured to detect a position of an object through a Lidar;
a memory configured to store data obtained based on the path finding and a down-scaled map generated based on the data; and
a processor functionally connected to the input unit, the sensing unit, and the memory to control an overall operation of the robot,
wherein the processor controls the robot to scan a surrounding environment of the robot by using the camera and the Lidar and generate the down-scaled map including a path structure of a symbolic form by using a connection line and an object placement structure where objects detected as a result of the scan are placed in a specific form.

2. The robot of claim 1, wherein the processor sets the detected object as a landmark and places a figure, representing the set landmark, in the specific form.

3. The robot of claim 1, wherein the processor sets a current position of the robot as center coordinates and places a figure, associated with the detected object, in the specific form with respect to a viewpoint of the robot on the detected object.

4. The robot of claim 3, wherein the specific form is a radial form, a grid form, or a tree form.

5. The robot of claim 1, wherein the processor recognizes a path of the surrounding environment through semantic segmentation and transforms a result of the recognition into a bird's eye view (BEV) form to generate the path structure of symbolic form.

6. The robot of claim 5, wherein the path comprises a pedestrian road, an intersection, and a crosswalk.

7. The robot of claim 5, wherein, when a difference between nodes detected based on occurrence of an event and nodes in a traveling path of the robot pre-stored in the memory is detected, the processor generates a node, detected based on the occurrence of the event, as a new node.

8. The robot of claim 7, wherein the processor reflects the generated new node in the traveling path of the robot to update the traveling path of the robot.

9. The robot of claim 8, wherein the occurrence of the event is a position change of an object, detection of a new object, or a change in the path of the surrounding environment.

10. A method of performing path finding by using a robot, the method comprising:
a step of scanning a surrounding environment of the robot by using a camera and a Lidar;
a step of generating a path structure of a symbolic form by performing semantic segmentation and bird's eye view (BEV) transformation on a path of the surrounding environment through the scanning;
a step of generating an object placement structure where objects detected through the scanning are placed in a specific form; and
a step of generating a down-scaled map including the path structure of symbolic form and the object placement structure.

11. The method of claim 10, wherein the step of generating the object placement structure comprises:
a step of setting a current position of the robot as center coordinates; and
a step of placing a figure, associated with the detected object, in the specific form with respect to a viewpoint of the robot on the detected object.

12. The method of claim 11, wherein the specific form is a radial form, a grid form, or a tree form.

13. The method of claim 10, wherein the step of generating the path structure of symbolic form comprises:
a step of recognizing the path of the surrounding environment through semantic segmentation; and
a step of transforming a result of the recognition into a BEV form.

14. The method of claim 13, wherein the path comprises a pedestrian road, an intersection, and a crosswalk.

15. The method of claim 13, further comprising a step of, when a difference between nodes detected based on occurrence of an event and nodes in a traveling path of the robot pre-stored in a memory is detected, generating a node, detected based on the occurrence of the event, as a new node.

16. The method of claim 15, further comprising a step of reflecting the generated new node in the traveling path of the robot to update the traveling path of the robot.

17. The method of claim 16, wherein the occurrence of the event is a position change of an object, detection of a new object, or a change in the path of the surrounding environment.

18. The method of claim 10, wherein the step of generating the object placement structure comprises:
a step of setting the detected object as a landmark; and
a step of placing a figure, representing the set landmark, in the specific form.

19. An autonomous driving apparatus for performing path finding, the autonomous driving apparatus comprising:
a memory configured to store data associated with path finding; and
a processor configured to scan a surrounding environment by using a camera and a Lidar, generate a path structure of a symbolic form by performing semantic segmentation and bird's eye view (BEV) transformation on a path recognized in the surrounding environment, generate an object placement structure where objects detected through the scan are placed in a specific form, and generate a down-scaled map including the path structure of symbolic form and the object placement structure.
